(19) United States
(12) Patent Application Publication
(10) Pub. No.: US 2026/0181402 A1
(43) Pub. Date: Jun. 25, 2026

(54) RADIO ZONE DESIGN SUPPORT APPARATUS, RADIO ZONE DESIGN SUPPORT METHOD AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(21) Appl. No.: 19/124,645

(22) PCT Filed: Nov. 9, 2022
(86) PCT No.: PCT/JP2022/041706

§ 371 Date: Apr. 25, 2025

(51) Int. Cl. H04W 16/18; H04W 24/02; H04W 24/10; H04W 48/16; H04W 88/06; H04W 88/08

(52) U.S. Cl. CPC H04W 16/18; H04W 24/02; H04W 24/10; H04W 48/16; H04W 88/06; H04W 88/08

(57) ABSTRACT

A radio zone design support apparatus includes: a first correction unit configured to correct a target value of quality information of wireless communication at one or more points on the basis of first quality information regarding wireless communication in an existing wireless system at the one or more points; and a calculation unit configured to calculate base station arrangement information regarding a new wireless system on the basis of the corrected target value, thereby supporting reduction of an increase in wireless network establishment cost.

### TECHNICAL FIELD

The present invention relates to a radio zone design support device, a radio zone design support method, and a program.

### BACKGROUND ART

In order to establish a coverage area of a wireless system, station placement design is performed in which base Station arrangement (installation locations and antenna directions) is determined. In the station placement design, the base station arrangement is selected and then a service area simulation is performed in some cases, and methods such as estimation by an experimental formula (Non-Patent Literature 1) and ray tracing (Non-Patent Literature 2) are used.

### CITATION LIST

### Non-Patent Literature

Non-Patent Literature 1:“Station Placement Design in Mobile Communication”, NTT DOCOMO Technical Journal vol.2 no. 4, [online], the Internet <https://www.nttdocomo.co.jp/binary/pdf/corporate/technology/rd/technical_journal/bn/vol2_4/vol2_4_035jp.pdf> Non-Patent Literature 2:“Ray Tracing Using Genetic Algorithm for Radio Wave Propagation Estimation”, NTT DoCoMo Technical Journal vol.15 no.3, [online], the Internet <https://www.nttdocomo.co.jp/binary/pdf/corporate/technology/rd/technical_journal/bn/vol15_3/vol15_3_020jp.pdf>

### SUMMARY OF INVENTION

### Technical Problem

As a new construction form of the wireless system, a form has been studied in which a target area is covered by a combination of a public wireless system (e.g., public 5G) and a private wireless system (e. g., local 5G). In such a case, while it is possible to acquire wireless quality information for each evaluation point for the public wireless system (existing wireless system, which is hereinafter referred to as a “wireless system E”), it is possible that the base station arrangement (locations and antenna directions) of the wireless system E becomes unknown.

In such a situation, in a conventional technology in which the base station arrangement is selected and then a service area simulation is performed, it is not possible to take a service area of the wireless system E into consideration, and in a case where a private wireless system (a new wireless system, which is hereinafter referred to as a “wireless system N”) is additionally installed, it is difficult to perform appropriate station placement design.

As a result, a problem may occur in which performing station placement design based on an assumption that the entire target area is covered by the wireless system N results in installation of base stations that are actually unnecessary, an excessive service area, and an increase in wireless network construction costs.

The present invention has been made in view of the above point, and an object of the present invention is to support a reduction in the increase in the wireless network construction costs.

### Solution to Problem

Thus, in order to solve the above problem, a radio zone design support apparatus includes: a first correction unit configured to correct a target value of quality information of wireless communication at one or more points on the basis of the first quality information regarding wireless communication in an existing wireless system at the one or more points; and a calculation unit configured to calculate base station arrangement information regarding a new wireless system on the basis of the corrected target value.

### Effect of Invention

It is possible to support a reduction in an increase in wireless network establishment costs.

### BRIEF DESCRIPTION OF DRAWINGS

FIG. 1 is a diagram illustrating a hardware configuration example of a radio zone design support apparatus 10 according to an embodiment of the present invention.

FIG. 2 is a diagram illustrating a functional configuration example of the radio zone design support apparatus 10 according to the embodiment of the present invention.

FIG. 3 is a flowchart for describing an example of a processing procedure executed by the radio zone design support apparatus 10.

FIG. 4 is a diagram illustrating an example of existing wireless area quality information.

FIG. 5 is a diagram illustrating an example of station placement design target information.

FIG. 6 is a diagram illustrating an example of corrected station placement design target information.

FIG. 7 illustrates information showing an example of station placement design evaluation result information.

FIG. 8 illustrates information showing an example of corrected station placement design evaluation result information.

### DESCRIPTION OF EMBODIMENTS

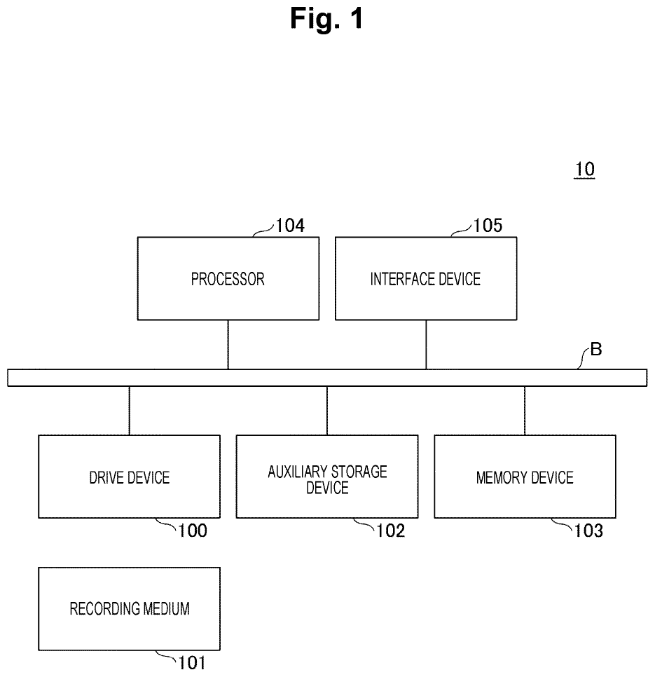

One or more embodiments of the present invention will be described below with reference to the drawings. FIG. 1 is a diagram illustrating a hardware configuration example of a radio zone design support apparatus 10 according to the embodiment of the present invention. The radio zone design support apparatus 10 in FIG. 1 includes a drive device 100, an auxiliary storage device 102, a memory device 103, a processor 104, an interface device 105, and the like, which are connected to one another by a bus B.

A program for implementing processing in the radio zone design support apparatus 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores required files, data, and the like.

In a case where a command to start the program is issued, the memory device 103 reads the program from the auxiliary storage device 102 and stores the program. The processor 104 is a CPU or a graphics processing unit (GPU), or includes a CPU and GPU, and executes a function relating to the radio zone design support apparatus 10 according to the program stored in the memory device 103. The interface device 105 is used as an interface for a connection to the network.

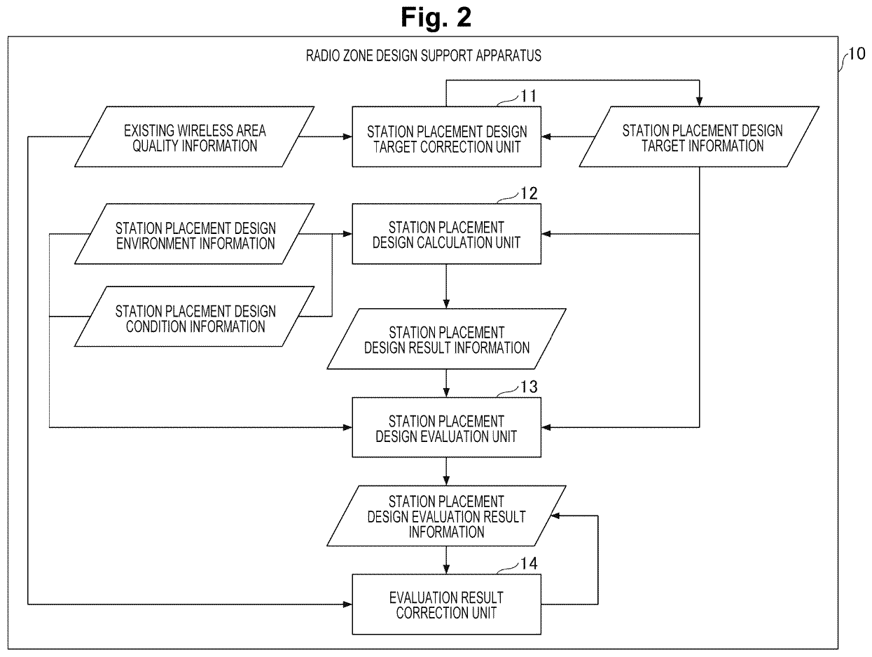

FIG. 2 is a diagram illustrating a functional configuration example of the radio zone design support apparatus 10 according to the embodiment of the present invention. In FIG. 2, the radio zone design support apparatus 10 includes a station placement design target correction unit 11, a station placement design calculation unit 12, a station placement design evaluation unit 13, and an evaluation result correction unit 14. Each of these units is implemented by processing that one or more programs installed in the radio zone design support apparatus 10 cause the processor 104 to execute.

Each unit need not be implemented by the same computer. For example, some or all of these units may be implemented by using different computers.

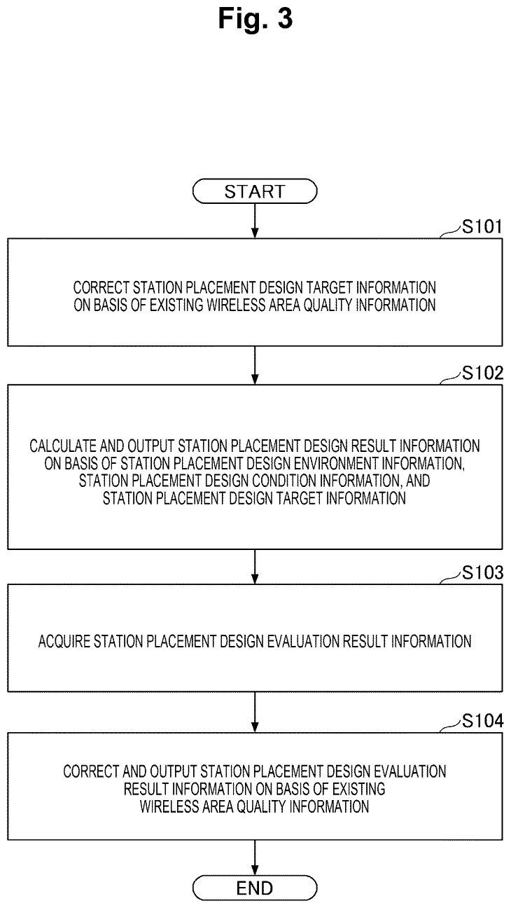

Hereinafter, a processing procedure executed by the radio zone design support apparatus 10 will be described. FIG. 3 is a flowchart for describing an example of the processing procedure executed by the radio zone design support apparatus 10.

In step S101, the station placement design target correction unit 11 receives, as an input, existing wireless area quality information and station placement design target information, and corrects the station placement design target information on the basis of the existing wireless area quality information.

The existing wireless area quality information is quality information (actual measurement values) regarding wireless communication that is performed in a state where only an existing wireless system (wireless equipment such as a base station) such as a public wireless system is used at one or more evaluation points arranged in a certain area (hereinafter simply referred to as a “target area”), which is a target for determining station placement design (determining arrangement (installation locations and antenna directions) of base stations for establishment of the coverage area of the wireless system). The evaluation points refer to points that are set in advance as locations where wireless communication is required to be possible in the target area. For example, one or more locations where it is assumed that terminals would be used are set as evaluation points.

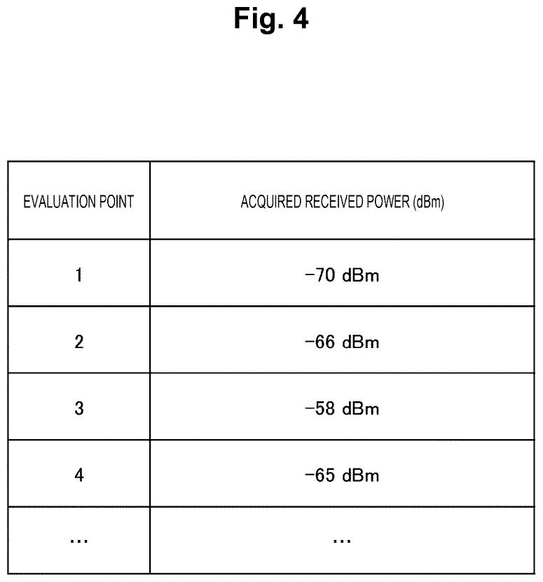

FIG. 4 is a diagram illustrating an example of the existing wireless area quality information. FIG. 4 illustrates, as an example of the existing wireless area quality information, information indicating an actual measurement value of received power in an existing wireless system at each evaluation point.

The station placement design target information is information indicating a target value of quality information regarding wireless communication at each evaluation point.

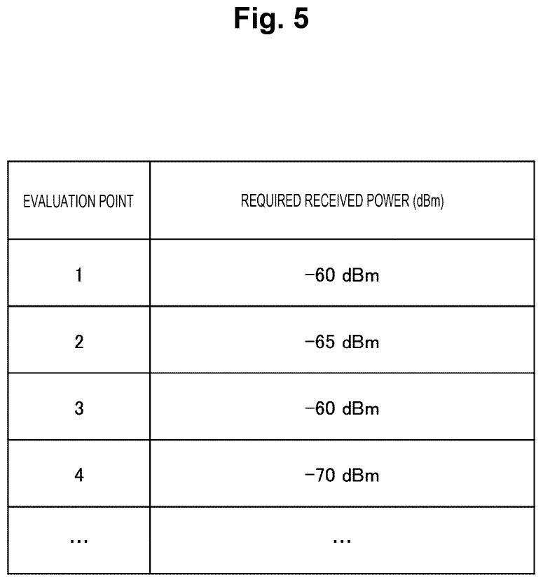

FIG. 5 is a diagram illustrating an example of the station placement design target information. FIG. 5 illustrates, as an example of the station placement design target information, information indicating required received power (required (or target) received power) at each evaluation point.

The station placement design target correction unit 11 corrects the station placement design target information, by changing the required received power to “none” (invalidating) at an evaluation point, among the evaluation points, at which received power of the existing wireless area quality information satisfies the required received power of the station placement design target information (the received power of the existing wireless area quality information is equal to or higher than the required received power of the station placement design target information).

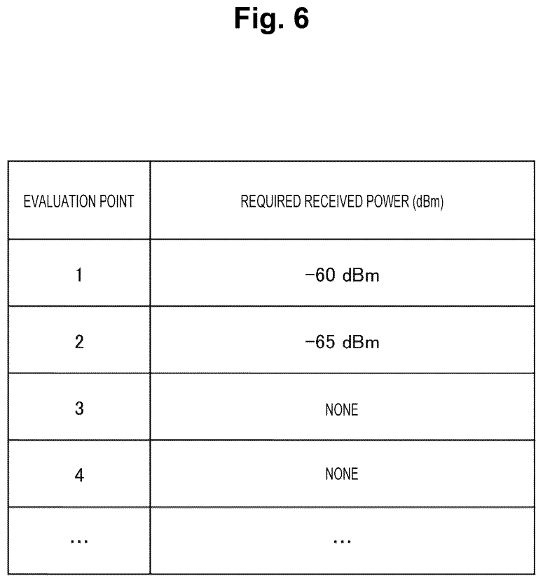

FIG. 6 is a diagram illustrating an example of the corrected station placement design target information. FIG. 6 illustrates an example of a result of correcting the station placement design target information in FIG. 5 on the basis of the existing wireless area quality information in FIG. 4. In FIG. 6, required received power values at evaluation points 3 and 4 have been corrected to “none”. This means that the required received power values are invalid at evaluation points 3 and 4.

Subsequently, the station placement design calculation unit 12 calculates station placement design result information on the basis of station placement design environment information, station placement design condition information, and the corrected station placement design target information (FIG. 6), and outputs the station placement design result information (S102). At this time, in the station placement design target information (FIG. 6), the required received power values at the evaluation points in which values are “none” are ignored.

The station placement design environment information is information that defines an environmental situation that affects the wireless communication in the target area. For example, the station placement design environment information is information indicating the size and shape of the target area, the range (position) and material of a structure, and the like.

The station placement design condition information is information indicating restriction conditions regarding performance and arrangement of a new wireless system (e.g., a private wireless system) that is a target of station placement design. For example, the station placement design condition information is information indicating a type of the wireless system for which station placement design is to be performed, information regarding a wireless base station device, the number of new wireless base stations that can be installed, and locations where the new wireless base stations can be arranged in the target area.

The station placement design result information is information (base station arrangement information) indicating a result of the station placement design regarding the new wireless system. For example, the station placement design result information is information indicating, as the station placement design result, the position and direction of the wireless base station device of the new wireless system in the target area.

Note that the calculation of the station placement design result information may be performed using the technology disclosed in Non-Patent Literature 1 or 2, or may be performed using any other known technology. For example, the technology used may be the technology disclosed in “Multi-Wireless Area Designing Method Based on Communication Capacity and Base Station Cost”, the Institute of Electronics, Information and Communication Engineers 2022 General Conference B-5-97, https://www.ieice-taikai.jp/2022general/jpn/webpro/_html/cs.html#b_5b”.

Subsequently, the station placement design evaluation unit 13 acquires station placement design evaluation result information regarding the new wireless system on the basis of the station placement design environment information, the station placement design condition information, the corrected station placement design target information, and the station placement design result information (S103). The station placement design evaluation result information is information indicating quality information of wireless communication, after installation of the new wireless system (not taking into consideration the existing wireless system), evaluated at each evaluation point arranged in the target area.

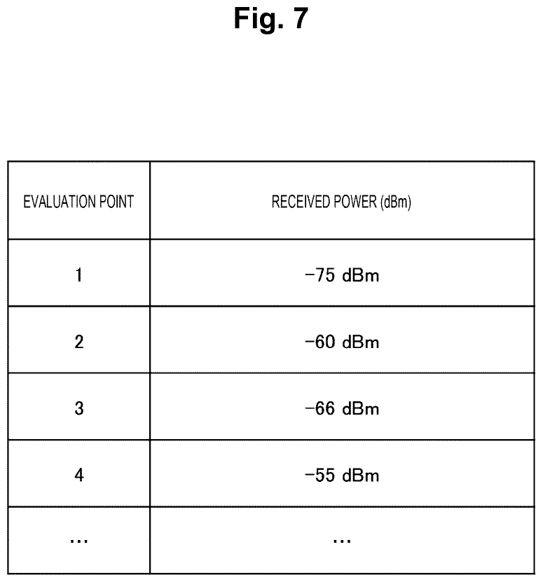

FIG. 7 illustrates information showing an example of the station placement design evaluation result information. FIG. 7 illustrates, as an example of the station placement design evaluation result information, information indicating received power, (from the new wireless system) after installation of the new wireless system, evaluated at each evaluation point.

The station placement design evaluation result information can be calculated by a simulation using the method disclosed in Non-Patent Literature 2. Alternatively, an actual measurement value of received power may be acquired after a new wireless system (new base station) is actually installed.

Subsequently, the evaluation result correction unit 14 corrects the station placement design evaluation result information (FIG. 7) on the basis of the existing wireless area quality information (FIG. 4), and outputs the corrected station placement design evaluation result information (S104). Specifically, for an evaluation point at which the received power of the existing wireless area quality information (FIG. 4) exceeds received power of the station placement design evaluation result information, the evaluation result correction unit 14 updates a value of the received power of the station placement design evaluation result information, with a value of the existing wireless area quality information.

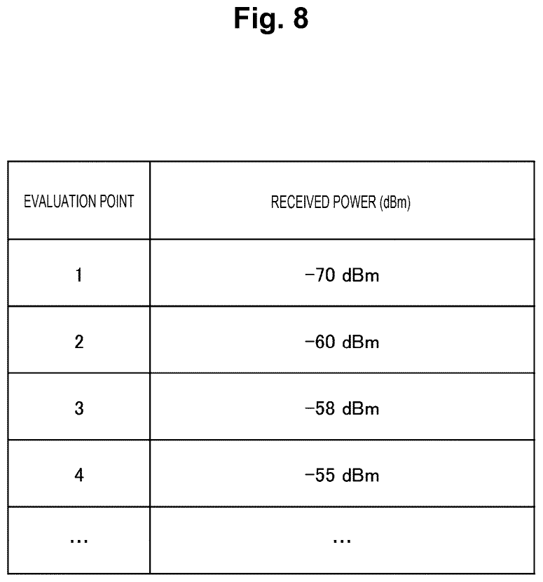

FIG. 8 illustrates information showing an example of the corrected station placement design evaluation result information. The station placement design evaluation result information in FIG. 8 indicates a result of correcting the station placement design evaluation result information in FIG. 7 on the basis of the existing wireless area quality information in FIG. 4. In this case, for evaluation points 1 and 3, greater values of the existing wireless area quality information (FIG. 4) are obtained, and thus received power values at these evaluation points have been updated with the greater values described above.

According to the corrected station placement design evaluation result information (FIG. 8), a user can add up quality of an existing wireless area and quality of a new wireless system, to thereby confirm and evaluate whether there are any overall issues.

In a case where the station placement design evaluation result information is unnecessary, steps S103 and S104 may not need to be executed. In this case, the radio zone design support apparatus 10 may not need to include the station placement design evaluation unit 13 and the evaluation result correction unit 14.

As described above, according to the present embodiment, it is possible to support a reduction in an increase in wireless network construction costs.

Specifically, by correcting target information in station placement design in a case of installing a new wireless system on the basis of wireless quality information for each evaluation point for an existing wireless system, it is possible to perform appropriate station placement design in a case of additionally installing the new wireless system in consideration of a service area of the existing wireless system. As a result, it is possible to prevent unnecessary base stations from being installed and prevent the service area from becoming excessive, thereby enabling a reduction in wireless network construction costs.

In addition, by correcting station placement design evaluation result information regarding the new wireless system on the basis of wireless quality information for each evaluation point for the existing wireless system, it is possible to evaluate the quality in consideration of both the existing wireless system and the new wireless system.

The above description is provided using an example in which the station placement design target information is required received power values at evaluation points arranged in a station placement design target area, but this is merely an example. For example, a signal-to-interference and noise ratio, or an acquired value such as a throughput value may be set as target information. In this case, when correcting station placement design target information, it is conceivable to perform correction processing after transforming the information.

The existing wireless system and the new wireless system may differ from each other in a frequency band and wireless system. In this case, when processing of correcting the station placement design target information is performed, information to be treated may be processed as information such as a throughput, instead of received power, such that a fair comparison between different frequency bands or/and between wireless systems can be performed.

In the present embodiment, the station placement design target correction unit 11 is an example of a first correction unit. The station placement design calculation unit 12 is an example of a calculation unit. The station placement design evaluation unit 13 is an example of an acquisition unit. The evaluation result correction unit 14 is an example of a second correction unit.

Although the embodiments of the present invention have been described in detail above, the present invention is not limited to specific embodiment(s), and various modifications and changes can be made within the scope of the gist of the present invention set forth in the claims.

### REFERENCE SIGNS LIST

10 Radio zone design support apparatus
11 Station placement design target correction unit
12 Station placement design calculation unit
13 Station placement design evaluation unit
14 Evaluation result correction unit
100 Drive device
101 Recording medium
102 Auxiliary storage device
103 Memory device
104 Processor
105 Interface device
B Bus

1. A radio zone design support apparatus comprising:
circuitry configured to:
correct a target value of quality information of wireless communication at at least one location based on first quality information regarding the wireless communication that is performed in an existing wireless system at the at least one location; and
calculate arrangement information of a base station in a new wireless system based on the corrected target value.

2. The radio zone design support apparatus according to claim 1, wherein the at least one location includes a first location at which the first quality information satisfies the target value, and
wherein the circuitry is configured to invalidate the target value for the first location.

3. The radio zone design support apparatus according to claim 1, wherein the circuitry is configured to:
acquire second quality information regarding wireless communication that is to be performed in the new wireless system at the at least one location in a case where the new wireless system is arranged based on the arrangement information of the base station; and
correct the second quality information based on the first quality information.

4. The radio zone design support apparatus according to claim 3, wherein the at least one location includes a first location at which the first quality information exceeds the second quality information, and
wherein the circuitry is configured to update the second quality information with the first quality information for the first location.

5. A radio zone design support method executed by a computer, comprising:
correcting a target value of quality information of wireless communication at at least one location based on first quality information regarding the wireless communication that is performed in an existing wireless system at the at least one location; and
calculating arrangement information of a base station in a new wireless system based on the corrected target value.

6. A non-transitory computer readable storage medium storing a program configured for causing a computer to execute a method, the method comprising:
correcting a target value of quality information of wireless communication at at least one location based on first quality information regarding the wireless communication that is performed in an existing wireless system at the at least one location; and
calculating arrangement information of a base station in a new wireless system based on the corrected target value.
